(19) United States
(12) Patent Application Publication
(10) Pub. No.: US 2019/0124958 A1
(43) Pub. Date: May 2, 2019

(54) ANTIMICROBIAL LIGNIN COMPOSITION DERIVED FROM WOOD BIOMASS

(71) Applicant: FPInnovations, Pointe-Claire (CA)

(72) Inventors: David Fei WONG, Kirkland (CA); Zhirun YUAN, Pointe-Claire (CA); Changbin MAO, Pierrefonds (CA)

(73) Assignees: FPInnovations, Pointe-Claire, QC (CA); FPInnovations, Pointe-Claire, QC (CA)

(21) Appl. No.: 16/305,941

(22) PCT Filed: Jun. 6, 2017
(86) PCT No.: PCT/CA2017/050685

§ 371 Date: Nov. 30, 2018

Related U.S. Application Data
(60) Provisional application No. 62/346,729, filed on Jun. 7, 2016.

(51) Int. Cl. A23L 3/3472; A23L 3/3562; A23L 3/349; A23B 4/20

(52) U.S. Cl. CPC A23L 3/3472; A23L 3/3562; A23V 2002/00; A23B 4/20; A23L 3/349

(57) ABSTRACT

An antimicrobial lignin composition derived from wood biomass for use as a food additive is described. The additive comprises enriched lignin, carbohydrates and water. A method of making a microbial inhibiting food matrix and a method of treating food to inhibit microbial growth are also described.

### FIELD

The present disclosure relates to food additives that inhibit microbial growth, and particularly to additives that derive from wood biomass. The present also relates to the method of making a microbial inhibiting food matrix and to a method of treating food to inhibit microbial growth.

### BACKGROUND

Lignocellulosic biomass refers to plant biomass that is composed of three main biopolymers: cellulose, hemicellulose and lignin. Lignocellulosic biomass provides the only renewable source of carbon and is currently an important source of renewable energy. Over 220 billion tonnes of biomass are produced each year but much remains underutilized. Increasing concerns about dependency on a limited and non-renewable fossil-based petroleum and coal resources for the production of both fuels and chemicals, as well as concerns about the environmental impact of burning fossil-based fuels, has resulted in a growing interest to find renewable resources for both fuels and chemicals.

The biorefinery concept, analogous to the petrochemical refinery, envisions using an abundant renewable resource such as lignocellulosic biomass as a potential feedstock for conversion to a range of products currently derived from petroleum, including fuels and chemicals.

Cellulose and hemicellulose are both examples of polysaccharides found in plant lignocellulosic biomass. These polysaccharides are also known as complex carbohydrates. By contrast, the third main biopolymer is lignocellulosic biomass. Lignin is a naturally occurring complex, high molecular weight aromatic macromolecule formed by the coupling of three different types of phenylpropanoid monomers (coniferyl, synapyl, and p-coumaryl alcohols), and is the only naturally occurring polymer having an aromatic ring structure. Lignin is found in the cell wall of plant biomass together with cellulose and hemicellulose. It is covalently bonded to the hemicellulose and functions to provide rigidity and structural support. Lignin is one of the most abundant polymers on earth and may constitute up to one-third of the material in lignocellulosic biomass.

To date, much of the biorefinery focus has been on developing the ‘sugar platform’ (products from the polysaccharides) to monetize the monosaccharide sugar streams derived from the cellulose and hemicellulose components, while the lignin component is considered a by-product having low commercial value. However, to maximize efficient utilization of the biomass resources and improve the overall process economics, the identification and development of high value applications for the large amounts of lignin that will be available becomes important.

The methods used in the biorefinery fractionation processes to separate the individual components of lignocellulosic biomass tend to yield lignin that, in general, is less modified from their native structure than the lignins obtained from the papermaking processes. Other methods have specifically been developed to isolate lignin from lignocellulosic biomass in high purity and with minimal modification from its native structure and with the objective to exploit them for high value products.

A mechanical fractionation process for wood described in U.S. Pat. No. 9,580,454 B2 and that is incorporated herein by reference in its entirety has been developed. This fractionation process facilitates the separation of the cellulose and hemicellulose components, leaving a lignin-rich residue from which a high purity enriched lignin having a chemical structure that closely resembles the native lignin found in the original wood can be further extracted.

The multiple aromatic ring structure of the lignin macromolecule classifies it in the category of polyphenolic compounds. Both phenolic and polyphenolic compounds are known to possess antioxidant activity, with the ability to scavenge free radicals and reactive oxygen species. Naturally occurring polyphenols are found in a wide variety of fruits, vegetables and cereal grains. It is recommended that the diet include sufficient contribution from these foods to ensure health and well-being. In a typical diet, polyphenols make up the major contribution of antioxidants consumed. Lignin and lignin hydrolysate products from plant biomass have been shown to possess strong anti-oxidant and anti-carcinogenic activity (Sharma et al. 2010, Lee et al. 2012). In addition to antioxidant activities in the diet, lignin has also demonstrated antioxidant activities in various industrial applications.

The wood-derived lignin products from in the biorefinery may offer potential as a natural food preservative and thus an alternative to synthetic chemically derived food preservatives for controlling microbial growth and may often contribute to good health.

### SUMMARY

In accordance with one embodiment herein described, there is provided an antimicrobial composition for inhibiting microbial growth in food comprising: an enriched lignin; carbohydrates; and water.

In accordance with another embodiment of the composition herein described, comprising 45% to 65% w/w enriched lignin in the composition, 30% to 35% w/w carbohydrates in the composition, wherein less than 10% w/w of the composition comprises water soluble components.

In accordance with another embodiment of the composition herein described, comprising 50% to 60% w/w the enriched lignin in the composition.

In accordance with another embodiment of the composition herein described, further comprising 3% w/w of protein.

In accordance with another embodiment of the composition herein described, wherein the composition is at a concentration from 4000 ppm to 32,000 ppm (0.4% to 3.2% w/w) in an aqueous media.

In accordance with another embodiment of the composition herein described, wherein the composition is at a concentration from 4000 ppm to 64,000 ppm (0.4% to 6.4% w/w) in a food matrix.

In accordance with another embodiment of the composition herein described, wherein the concentration is 32,000 ppm to 64,000 ppm (3.2% to 6.4% w/w).

In accordance with another embodiment of the composition herein described, wherein the carbohydrates are selected from group consisting of monomeric sugars, oligosaccharides, polysaccharides and combinations thereof.

In accordance with another embodiment herein described, there is provided a method of making a microbial growth inhibiting food matrix comprising: providing an antimicrobial composition herein described, pasteurizing the antimicrobial composition; providing a food matrix; mixing the pasteurized antimicrobial composition with the food matrix.

In accordance with another embodiment of the method herein described, wherein the food matrix is an aqueous broth or a solid food matrix.

In accordance with another embodiment of the method herein described, wherein the antimicrobial composition is dosed into the aqueous broth at concentrations of 4000 ppm to 32,000 ppm (0.4%-3.2% w/w).

In accordance with another embodiment of the method herein described, wherein the antimicrobial composition is dosed into the solid food matrix at concentrations of 4000 ppm to 64,000 ppm (0.4%-6.4% w/w).

In accordance with another embodiment of the method herein described, where the concentration in the solid food matrix is 32,000 ppm to 64,000 ppm (3.2%-6.4% w/w).

In accordance with another embodiment of the method herein described, where the concentration in the solid food matrix is 32,000 ppm (3.2% w/w).

In accordance with another embodiment of the method of treating food to inhibit microbial growth comprising adding a microbial inhibiting amount of a composition comprising an enriched lignin; carbohydrates; and water to the food.

In accordance with another embodiment of the method herein described, wherein the composition comprises 45% to 65% w/w enriched lignin in the composition, 30% to 35% w/w carbohydrates in the composition, and less than 10% w/w of water soluble components in the composition.

In accordance with another embodiment of the method herein described, wherein the composition comprises 50% to 60% w/w enriched lignin in the composition.

In accordance with another embodiment of the method herein described, wherein the composition further comprising 3% w/w of protein.

In accordance with another embodiment of the method herein described, wherein the microbial inhibiting amount is a concentration from 4000 ppm to 32,000 ppm (0.4% to 3.2% w/w) in an aqueous media.

In accordance with another embodiment of the method herein described, wherein the microbial inhibiting amount is a concentration from 4000 ppm to 64,000 ppm (0.4% to 6.4% w/w) in a food matrix.

In accordance with another embodiment of the method herein described, wherein the concentration is 32,000 ppm to 64,000 ppm (3.2% to 6.4% w/w).

In accordance with another embodiment of the method herein described, wherein the carbohydrates are selected from group consisting of monomeric sugars, oligosaccharides, polysaccharides and combinations thereof.

### BRIEF DESCRIPTION OF THE DRAWINGS

FIG. 1 is a generalized process block diagram of the biorefinery described in U.S. Pat. No. 9,580,454 B2 (PRIOR ART);

FIG. 2 is a graph of growth of listeria monocytogenes in suspensions of a hydrolysis lignin in accordance with one embodiment presented herein (4000 ppm and 32,000 ppm) in a liquid culture media (tryptic soy broth) versus incubation time (hours), that also illustrates growth of listeria monocytogenes with a commercially available antimicrobial food additive (Saf-T-Lac®); and

FIG. 3 is a bar chart of growth inhibition of listeria monocytogenes in a solid food matrix, a pork based meat spread, by the hydrolysis lignin in accordance with another embodiment presented herein at concentrations of 32000 ppm and 64000 ppm.

### DEFINITIONS

Lignin is a naturally occurring complex, high molecular weight aromatic macromolecule formed by the coupling of three different types of phenylpropanoid monomers (coniferyl, synapyl, and p-coumaryl alcohols), and is a naturally occurring polymer having aromatic ring structure.

Hydrolysis Lignin is defined as an enzymatically treated lignin from the lignin fraction produced by the process of U.S. Pat. No. 9,580,454 B2. Hydrolysis lignin comprises at least three components: enriched lignin, carbohydrates, and water.

Enriched lignin is understood to be the lignin containing constituent of hydrolysis lignin and makes up approximately 50% lignin w/w in hydrolysis lignin and has properties that are substantially similar to that of a native lignin found in the biomass from which the enriched lignin derives. The enriched lignin remains a high molecular weight water insoluble macromolecule with its molecular structure essentially unchanged from that of native lignin.

An antimicrobial composition for food is understood to inhibit the microbial activity in food, where the food is understood to comprise both liquid, solid and semi-solid materials. Inhibiting microbial growth is understood as reducing or stopping the growth of microbes, particularly bacteria.

A food matrix is understood as a prepared food substance including ingredients such a protein, fiber, seasoning and preservatives.

Listeria monocytogenes is a virulent species of pathogenic gram positive bacteria, that causes the disease listeriosis that is a leading cause of death due to foodborne bacterial pathogens. Listeria monocytogenes can survive in the presence or absence of oxygen and grow at temperatures as low as 0° C. Unlike other bacteria that cause food poisoning, L. monocytogenes can survive and grow on foods stored at refrigeration temperatures, but can be killed with proper cooking or pasteurization. Listeria monocytogenes is a division of Firmicutes and is related to six gram-positive genera that are typically pathogenic in humans. The six genera are: Streptococcus, Staphylococcus, Corynebacterium and Listeria (a coccobacillus), Bacillus and Clostridium.

### DETAILED DESCRIPTION

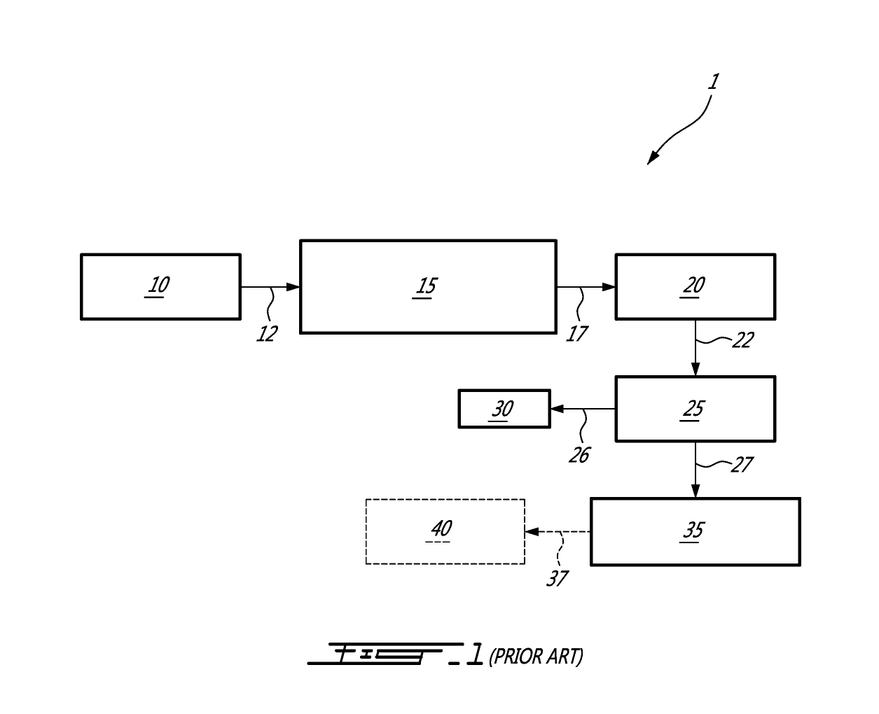

FIG. 1 illustrates a generalized prior art process 1 of published U.S. Pat. No. 9,580,454 B2 the contents of which are incorporated by reference herein in their entirety. The process 1 produces value-added products from wood-based lignocellulose. The process 1 begins with wood biomass preparation 10, where wood biomass 12 is prepared in a preferred embodiment. The wood biomass 10 is wood chips. The prepared wood biomass 12 undergoes a mild chemical treatment and size reduction in a refiner mechanical fractionation 15. The chemically/mechanically treated biomass 17 undergoes an enzymatic hydrolysis 20. Cellulolytic enzymes are used to convert the chemically/mechanically treated biomass 17 including carbohydrate constituents into an enzymatically hydrolyzed biomass 22 including a sugar solution stream 26 comprised mainly of the monomeric sugars glucose and xylose from the enzymatic hydrolysis of cellulose and hemicellulose. This sugar stream 26 can be further treated to dry and/or crystallize 30 the sugar stream 26.

The enzymatically hydrolyzed biomass 22 undergoes a liquid-solid separation (fractionation) process 25 that includes: a washing that improves sugar recovery (to stream 26); and a solid fraction separation/fractionation step that produces a so-called hydrolysis lignin 27 having an enriched lignin as a component. The mild conditions of the process of U.S. Pat. No. 9,580,454 B2 results in the lignin 27 that is essentially unaltered in chemical structure and composition from a native state lignin within the wood-based lignocellulose and is free from impurities (i.e. sulfur). The characteristics of hydrolysis lignin 27 are summarized in Table 1.

TABLE 1
Composition of Hydrolysis Lignin 27

| | Weight % of total |
|---|---|
| Component of Hydrolysis Lignin 27 | Hydrolysis Lignin |
| Enzymatically treated enriched | 45-65% |
| Lignin or Near-Native Lignin | |
| Carbohydrates (Saccharides | 25-45% |
| of cellulose and hemicellulose) | |
| Protein | 3% |
| Ash Content | 0.6% |
| Sulfur Content | 0.05% |
| Solubility in Water | <10% |

The hydrolysis lignin 27 from the fractionation process 25 produces a composition consisting of approximately 45 to 65% w/w of an enriched lignin, and preferably 50% to 60% of enriched lignin by weight of the hydrolysis lignin. The enriched lignin component of the hydrolysis lignin is understood to be an enzymatically treated lignin and having substantially the properties of native lignin i.e. is a near-native lignin. The carbohydrate portion of the hydrolysis lignin 27, makes up 25%-45%, preferably 30% to 40%, by weight of the hydrolysis lignin 27, and is comprised of a fraction of water soluble monomer sugars and oligosaccharides (less than 10% by weight), and an insoluble fraction. The insoluble fraction of the carbohydrate portion comprises poly- and oligosaccharides derived from cellulose and hemicellulose, having a range of degree of polymerization (DP) of <10 to >1000. The carbohydrate components and the lignin may or may not be chemically linked together in the hydrolysis lignin 27.

It has surprisingly been found that an aqueous suspension of hydrolysis lignin 27 displayed antimicrobial activity in-vitro against the bacteria Listeria monocytogenes. While antibacterial properties of native lignin has been described in the prior art, this present finding is surprising because the hydrolysis lignin 27 from the fractionation process 25 has only about 50% to 60% lignin content by weight of the total mass. The process of U.S. Pat. No. 9,580,454 B2 also allows for the production of a high purity, carbohydrate-free lignin 37, that also resembles near-native lignin in chemical composition and structure. The lignin 37 can be extracted from hydrolysis lignin via solvent extraction 35 using either aqueous or organic solvents under mild reaction conditions (FIG. 1).

Interestingly, the high purity extracted lignin 37, in contrast to the hydrolysis lignin 27, did not demonstrate the antibacterial activity 40 against Listeria monocytogenes. Similarly, a kraft lignin isolated from the black liquor of the papermaking process made using patented process of U.S. Pat. No. 8,771,464 B2, the contents of which are incorporated herein by reference in their entirety, was tested under the similar conditions did not show antibacterial activity against Listeria monocytogenes. While not excluding other possible explanations, and without wishing to be tied to a theory, it appears that a combination of lignin and carbohydrates provides an antimicrobial effect in various food media.

Interestingly, complete solubility of the hydrolysis lignin in the aqueous bacteria medium is not a requirement for hydrolysis lignin 27 to demonstrate antibacterial activity. The hydrolysis lignin 27 possesses only low solubility in water at physiological pH, with only a small portion (less than 10% w/w) of the carbohydrate components, namely the monomeric sugars, becoming solubilized. In contrast, the prior art teaches that most plant-derived extracts exhibiting antimicrobial properties need to be completely solubilized in the solvent medium in order to manifest this activity.

In another aspect of this disclosure, the hydrolysis lignin 27 demonstrates antibacterial activity against Listeria monocytogenes in challenge tests in a solid food matrix that is highly conducive to microbial growth. Factors that favour microbial growth in foods include high water activity (a_{w}>0.92), non-acidic pH environment (pH >4.4), and an available source of nutrients. While dispersed within the food matrix at concentrations between 0.4% and 6.4% and preferably 3.2% and 6.4% on w/w basis, hydrolysis lignin inhibited growth of the bacteria, prolonging shelf life, the storage time after which food is still deemed safe to eat.

The application of the herein described composition is demonstrated in the following examples below.

### Example 1

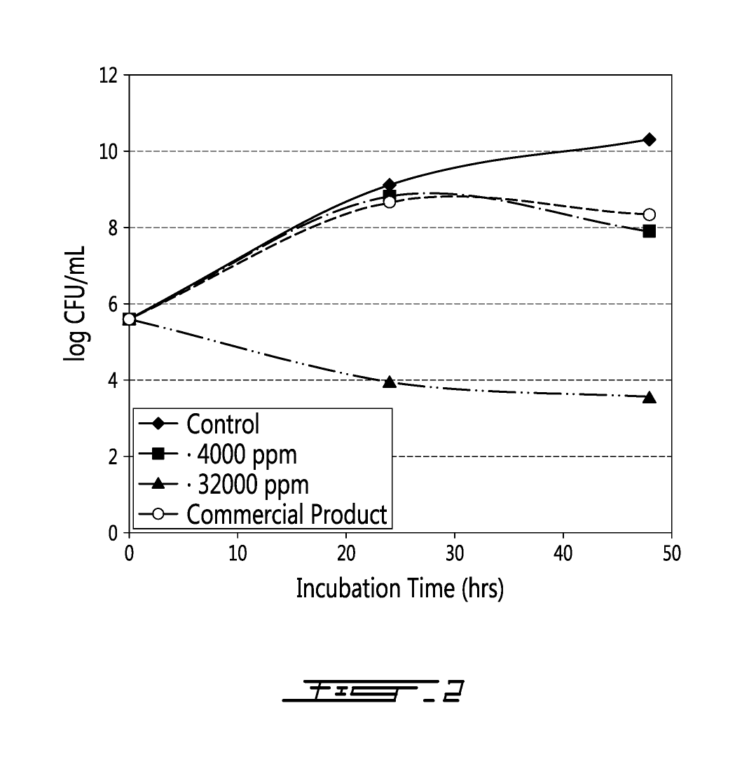

A suspension of hydrolysis lignin 27 in purified deionized water is prepared to a solids content of 5% w/w. The suspension was pasteurized by heating to 75° C. for 10 minutes and then stored refrigerated until used to minimize bacterial growth. Dilutions of the stock hydrolysis lignin suspension were made in Tryptic Soy Broth (TSB) culture media to yield suspensions containing 4000 ppm (0.4% w/w) and 32,000 ppm (3.2% w/w) hydrolysis lignin. A 25 mL aliquot of each suspension was inoculated with a mixture containing equal portions of three strains of listeria monocytogenes (ATCC 7644, ATCC 19114, and ATCC 19115) to a targeted concentration of 1×10⁶ CFU/mL. The inoculated samples were incubated at 37° C. for 48 hours with constant agitation (196-200 rpm). A count of the bacterial population was made at t=0 hours, 24 hours and 48 hours. Small aliquots were removed and cultured for 24 hours on selective media (Oxford agar) before counting. The results are presented in FIG. 2 where they are compared with a commercially available antimicrobial product, Saf-T-Lac™ that was used at a concentration of 25,000 ppm (2.5% w/w). The commercial product and the 4000 ppm (0.4% w/w) of the hydrolysis lignin, despite having a concentration more than 6 times less, had comparable antimicrobial performance. Interestingly, the 32,000 ppm (3.2% w/w) concentration hydrolysis lignin acts not only as an antimicrobial it acts as a bacteriocide killing listeria monocytogenes. The present hydrolysis lignin wood-derived product offers potential as a natural food preservative and an alternative to synthetic chemically derived food preservatives for controlling microbial growth.

### Example 2

A suspension of hydrolysis lignin 27 in purified deionized water was prepared to a solids content of approximately 10%. The suspension was pasteurized by heating to 75° C. for 10 minutes and then stored refrigerated until used, to minimize bacterial growth. A pork meat spread of composition shown in Table 2 was used as the solid food matrix, its high water activity and non-acidic pH favoring bacteria growth.

TABLE 2
Ingredients in Pork Spread (presented as a % w/w)

| | | 3.2% w/w | 6.4% w/w |
|---|---|---|---|
| | | hydrolysis | hydrolysis |
| Ingredient | Control | lignin | lignin |
| Ground Pork | 67.7 | 65.2 | 63.3 |
| Water | 21.5 | 21.3 | 20.3 |
| Bread Crumbs | 6.9 | 6.6 | 6.4 |
| Salt | 2.26 | 2.15 | 2.11 |
| Onion Powder | 0.27 | 0.26 | 0.26 |
| Garlic Powder | 0.10 | 0.09 | 0.09 |
| Crushed Clove | 0.03 | 0.03 | 0.03 |
| Cinnamon | 0.02 | 0.02 | 0.02 |
| Dehydrated Onion | 1.26 | 1.21 | 1.17 |
| Hydrolysis Lignin (27) | 0 | 3.2 | 6.4 |

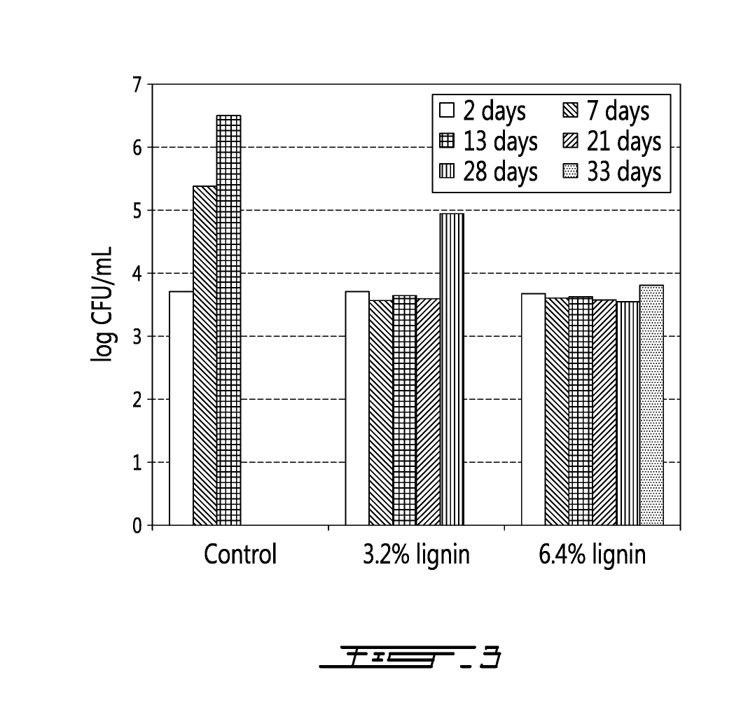

All testing was performed in duplicate. The hydrolysis lignin was directly incorporated into the meat spread as an ingredient, at concentrations of either 3.2% or 6.4% on weight/weight basis of the spread. A control sample contained no hydrolysis lignin in its ingredients. After cooking, the prepared samples of the pork spread were innoculated with listeria monocytogenes at an approximate dose of 5×10³ CFU/mL, mixed and then incubated at 4° C. On days 2, 7, 14, 21, 28 and 34, samples (50 g in size) were removed, diluted with peptone water and homogenized. After further dilution, the sample was plated on Palcam agar, and then incubated at 37° C. for 48 hours before bacterial counting. The results are illustrated in FIG. 3.

As can be seen in FIG. 3, in the control meat spread (without the hydrolysis lignin) showed clear and steady growth of the listeria monocytogenes. The meat spread that included 3.2% w/w of hydrolysis lignin showed virtually no increase in bacterial growth of listeria monocytogenes for the first three weeks. Finally, the meat spread with 6.4% w/w of hydrolysis lignin showed virtually no increase in bacterial growth of listeria monocytogenes for more than 1 month.

### REFERENCES

Sharma, R. K., Chandra, P., Arora, D. S., “Antioxidant properties and nutritional value of wheat straw processed by Phanerochaete chrysosporium and Daedalea flavida.” J. Gen. Appl. Microbiol., 56, p 519-523, (2010).
Lee, S., Monnappa, A. K., Mitchell, R. J., “Biological activities of lignin hydrolysate-related compounds.” BMB Reports, p 265-274, (2012).
Pouteau, C., Dole, P., Cathala, B., Averous, L., Boquillon, N., “Antioxidant properties of lignin in polypropylene.” Polym. Degrad. Stab., 81, p 9-18, (2003).
Xin, J., Saka, S., “Improvement of the oxidation stability of biodiesel as prepared by supercritical methanol method with lignin.” Eur. J. Lipid Sci. Technol., 111, p 835-842, (2009).
Baurhoo, B., Ruiz-Feria, C. A., Zhao, X., “Purified lignin: Nutritional and health impacts on farm animals—A review.” Anim. Feed Sci. Technol., 144, p 175-184, (2008).
Dong, X., Dong, M., Turley, A., Jin, T., Wu, C., “Antimicrobial and antioxidant activities of lignin from residue of corn stover to ethanol production.” Ind. Crop Prod., 34, p 1629-1634, (2011).
Sláviková, E., Kosíková, B., “Inhibitory Effect of Lignin By-products of Pulping on Yeast Growth.” Folia Microbiol., 39(3), p 241-243, (1994).
Goy, R. C., de Britto, D., Assis, O. B. G., “A Review of the Antimicrobial Activity of Chitosan.” Polimeros: Ciência e Technologia, 19, p 241-247, (2009).
Sakagami, H., Kushida, T., Oizumi, T., Nakashima, H., Makimo, T., “Distribution of lignin-carbohydrate complex in plant kingdom and its functionality as alternative medicine.” Pharm Thera, 128, p 91-105, (2010).
Jiao, G., Yu, G., Zhang, J., Ewart, “Chemical Structures and Bioactivities of Sulfated Polysaccharides from Marine Algae.” Mar. Drugs, 9, p 196-223, (2011).
Barreteau, H., Delattre, C., Michaud, P., “Production of Oligosaccharides as Promising New Food Additive Generation.” Food Technol. Biotechnol., 44, p 323-333, (2006).
Gaggia, F., Mattarelli, P., Biavati, B., “Probiotics and prebiotics in animal feed for safe food production.” Int. J. Food Microbiol., 141, S15-S28, (2010).
Phillips, G. O., “Dietary fibre: A chemical category or health ingredient?” Bioactive Carbohydrates and Dietary Fibre, 1, p 3-9, (2013).

1. An antimicrobial composition of hydrolysis lignin, for inhibiting microbial growth in food comprising:
an enriched lignin with a molecular weight of >10,000 Daltons;
carbohydrates; and
water.

2. The composition of claim 1, comprising 45% to 65% w/w enriched lignin in the composition, 30% to 35% w/w carbohydrates in the composition, wherein less than 10% w/w of the composition comprises water soluble components.

3. The composition of claim 2, comprising 50% to 60% w/w the enriched lignin in the composition.

4. The composition of claim 1, further comprising 3% w/w of protein.

5. The composition of claim 1, wherein the composition is at a concentration from 4000 ppm to 32,000 ppm (0.4% to 3.2% w/w) in an aqueous media.

6. The composition of claim 1, wherein the composition is at a concentration from 4000 ppm to 64,000 ppm (0.4% to 6.4% w/w) in a food matrix.

7. The composition of claim 6, wherein the concentration is 32,000 ppm to 64,000 ppm (3.2% to 6.4% w/w).

8. The composition of claim 1, wherein the carbohydrates are selected from group consisting of monomeric sugars, oligosaccharides, polysaccharides and combinations thereof.

9. A method of making a microbial growth inhibiting food matrix comprising:
providing the antimicrobial composition of claim 1,
pasteurizing the antimicrobial composition;
providing a food matrix;
mixing the pasteurized antimicrobial composition with the food matrix.

10. The method of claim 9, wherein the food matrix is an aqueous broth or a solid food matrix.

11. The method of claim 9, wherein the antimicrobial composition is dosed into the aqueous broth at concentrations of 4000 ppm to 32,000 ppm (0.4%-3.2% w/w).

12. The method of claim 9, wherein the antimicrobial composition is dosed into the solid food matrix at concentrations of 4000 ppm to 64,000 ppm (0.4%-6.4% w/w).

13. The method of claim 12, where the concentration in the solid food matrix is 32,000 ppm to 64,000 ppm (3.2%-6.4% w/w).

14. The method of claim 12 or 13, where the concentration in the solid food matrix is 32,000 ppm (3.2% w/w).

15. Method of treating food to inhibit microbial growth comprising
adding an microbial inhibiting amount of a composition of hydrolysis lignin comprising an enriched lignin with a molecular weight of >10,000 Daltons; carbohydrates; and water to the food.

16. The method of claim 15, wherein the composition comprises 45% to 65% w/w enriched lignin in the composition, 30% to 35% w/w carbohydrates in the composition, and less than 10% w/w of water soluble components in the composition.

17. The method of claim 16, wherein the composition comprises 50% to 60% w/w enriched lignin in the composition.

18. The method of claim 15, wherein the composition further comprising 3% w/w of protein.

19. The method of claim 15, wherein the microbial inhibiting amount is a concentration from 4000 ppm to 32,000 ppm (0.4% to 3.2% w/w) in an aqueous media.

20-21. (canceled)

22. The method of claim 15, wherein the carbohydrates are selected from group consisting of monomeric sugars, oligosaccharides, polysaccharides and combinations thereof.
